(19) United States
(12) Patent Application Publication
(10) Pub. No.: US 2020/0400196 A1
(43) Pub. Date: Dec. 24, 2020

(54) OFF-ANGLE SCREW ENGAGEMENT

(71) Applicant: Evollution IP Holdings, Inc., Birmingham, AL (US)

(72) Inventor: Thierry M. Giorno, Boca Raton, FL (US)

(21) Appl. No.: 16/958,783

(22) PCT Filed: Feb. 13, 2019
(86) PCT No.: PCT/US2019/017765

§ 371 Date: Jun. 29, 2020

Related U.S. Application Data
(60) Provisional application No. 62/636,395, filed on Feb. 28, 2018.

(51) Int. Cl. F16D 3/18; B25B 15/00; B25B 23/00

(52) U.S. Cl. CPC F16D 3/185; B25B 23/0035; B25B 15/005

(57) ABSTRACT

A screw engagement system comprising a screw and a driver. The screw may comprise a recess in the screw head and a plurality of grooves arranged circumferentially around and formed radially outwardly into the screw head from an inner circumferential surface of the screw head recess. The driver may comprise a driver head having the general shape of a spherical frustum and including a plurality of splines that engage the screw head recess grooves and transmit torque and impart rotational motion to the screw therethrough.

### CROSS-REFERENCES TO RELATED APPLICATIONS

This patent application claims priority from U.S. Provisional Patent Application Ser. No. 62/636,395 filed Feb. 28, 2018 and Patent Cooperation Treaty International Patent Application Serial Number PCT/US2019/017765 filed Feb. 13, 2019, the entire contents of which are incorporated herein.

### STATEMENT REGARDING FEDERALLY SPONSORED RESEARCH OR DEVELOPMENT

Not Applicable

### BACKGROUND

### Field

This application relates generally to off-axis engagement capability of a screw and screw driver.

### DESCRIPTION OF RELATED ART INCLUDING INFORMATION DISCLOSED UNDER 37 CFR 1.97 AND 1.98

Some screw and screw driver configurations are known to be capable of driving screws when the screw driver and screw are not in precise co-axial alignment. However, the degree to which such configurations provide for off-axis engagement is limited by a lack of design elements that specifically enhance off-axis engagement range.

### SUMMARY

A screw engagement system is provided for transmission of torque and rotational motion from a screw driver to a screw. The system includes a screw comprising a screw shaft axially extending from a screw head, and a screw head recess formed axially into the screw head from an end surface of the screw head. The screw head recess includes a plurality of screw head recess grooves arranged circumferentially around and formed radially outwardly into the screw head from an inner circumferential surface of the screw head recess. The system also includes a driver comprising a driver head having the general shape of a spherical frustum and including a plurality of splines that are defined by driver head grooves formed into and arrayed circumferentially around the driver head. The splines are configured to engage the screw head recess grooves and transmit torque and impart rotational motion to the screw therethrough.

Also provided is screw that comprises a screw shaft axially extending from a screw head and a screw head recess formed axially into the screw head from an end surface of the screw head. The screw head recess includes six screw head recess grooves arranged circumferentially around and formed radially outwardly into the screw head from an inner circumferential surface of the screw head recess. The screw head recess is configured to receive a driver comprising a driver head having the general shape of a spherical frustum and including a plurality of driver head splines that are defined by driver head grooves formed into and arrayed circumferentially around the driver head, the screw head recess grooves being configured and positioned to receive and engage the driver head splines and to receive torque transmission and rotational motion therethrough. The screw head recess is also configured to receive a driver comprising a driver head having the general shape of a hexagonal prism and including six driver head corners that are defined by intersections of six facets arrayed circumferentially around the driver head, the screw head recess grooves being configured and positioned to receive and engage the driver head corners and to receive torque transmission and rotational motion therethrough.

### DRAWING DESCRIPTIONS

FIG. 1 is a partial front view of an illustrative embodiment of an off-angle screw engagement system, a screw driver and screw of the system being shown in coaxial engagement;

FIG. 2 is a partial front view of the off-angle screw engagement system of FIG. 1, with the screw driver and screw shown in non-coaxial engagement;

FIG. 3 is a partial front view of the off-angle screw engagement system of FIGS. 1 and 2, with the screw driver and screw shown in non-coaxial engagement and with a head portion of the screw partially cut-away to show engagement of a head of the screw driver in a head recess of the screw;

FIG. 4 is a front view of the screw driver of FIGS. 1-3;

FIG. 5 is a right end view of the screw driver of FIG. 4;

FIG. 6 is a left end view of the screw driver of FIG. 4;

FIG. 7 is a magnified partial front view of the head portion of the screw driver of FIG. 4;

FIG. 8 is a magnified partial view of the head portion of the screw driver of FIG. 4 having been rotated 30 degrees about a longitudinal axis of the screw driver;

FIG. 9 is a cross-sectional view of the head portion of the screw driver of FIG. 4 taken along line 9-9 of FIG. 7;

FIG. 10 is a front view of the screw of FIGS. 1-3;

FIG. 11 is a right end view of the screw of FIG. 10;

FIG. 12 is a cross-sectional view of a head portion of the screw of FIG. 10 taken along line 12-12 of FIG. 11;

FIG. 13 is a cross-sectional view of the head portion of the screw of FIG. 10 taken along line 13-13 of FIG. 11;

FIG. 14 is a cross-sectional view of the screw and screw driver of FIG. 1 taken along line 14-14 of FIG. 1;

FIG. 15 is a partial front view of an illustrative embodiment of an off-angle screw engagement system, a screw of the system and a conventional hex-head cap screw driver being shown spaced axially from one another;

FIG. 16 is a partial front view of an illustrative embodiment of an off-angle screw engagement system, a screw of the system and a conventional hex-head cap screw driver being shown in coaxial engagement; and

FIG. 17 is a cross-sectional view of the screw and conventional cap screw driver of FIGS. 15 and 16, taken along line 17-17 of FIG. 16.

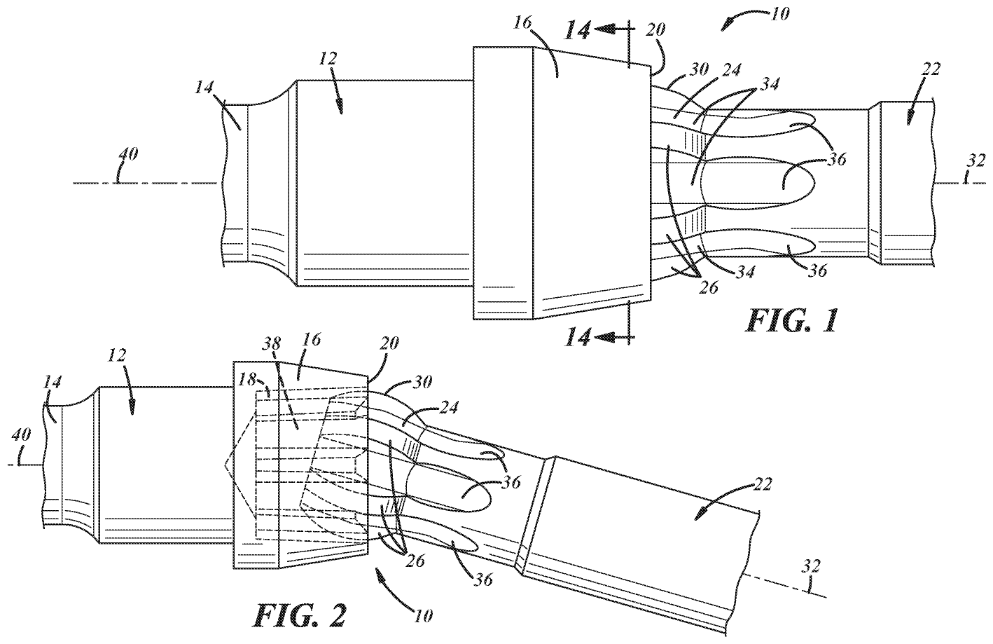

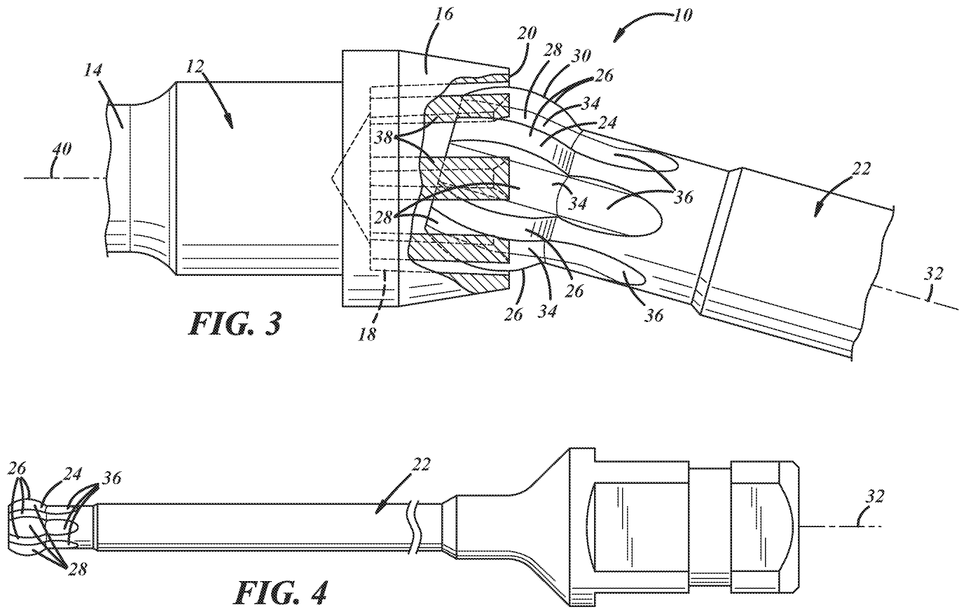

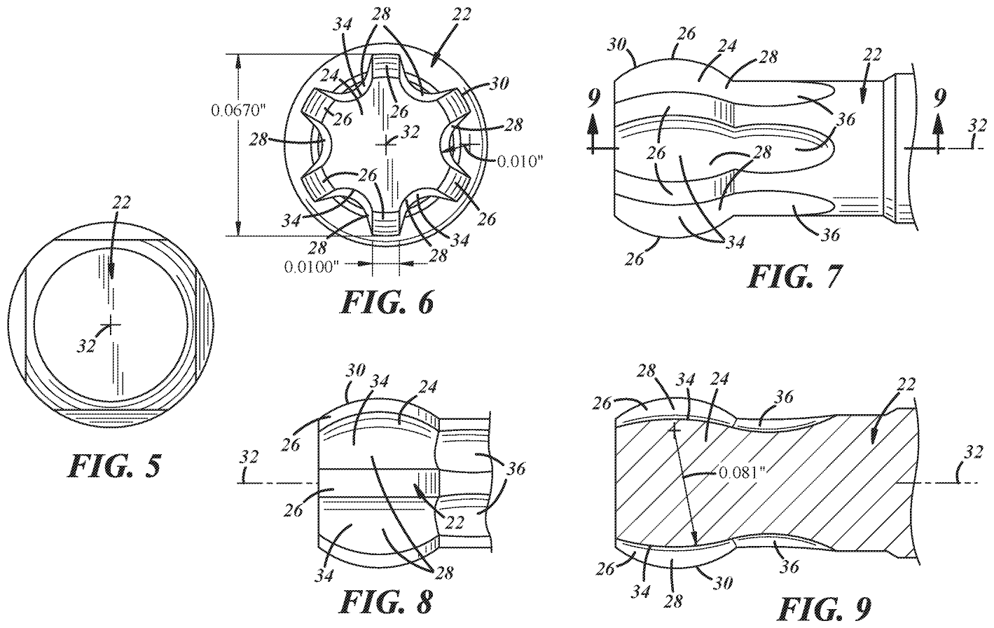

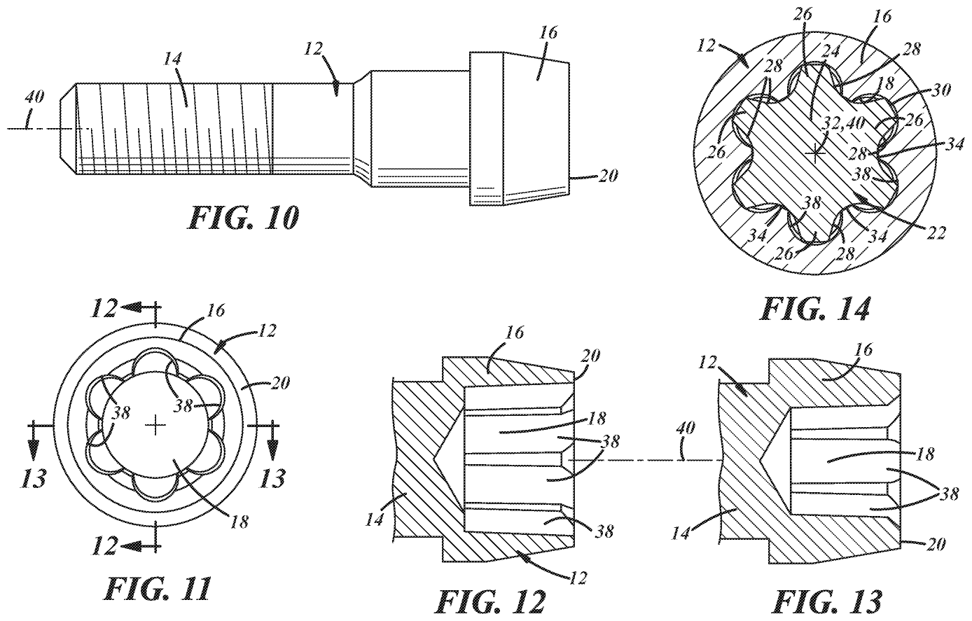

### DETAILED DESCRIPTION

A screw engagement system that allows for off-axis transmission of torque and rotational motion from a screw driver to a screw, is generally shown at 10 in the drawings. The system 10 may include a screw 12 that may comprise a screw shaft 14 axially and integrally extending from a screw head 16. A screw head recess 18 may be formed axially into the screw head 16 from an end surface 20 of the screw head 16 opposite the screw shaft 14.

The system 10 may also include a screw driver 22 having a screw driver head 24 configured to engage the screw head recess 18 and to transmit torque and impart rotational motion to the screw 12 therethrough. The screw head recess 18 may be configured to receive the screw driver head 24 and to transmit torque and rotational motion from the screw driver 22 to the screw 12.

The screw driver head 24 may have the general shape of a spherical frustum and may include a plurality of longitudinal ribs or splines 26 defined by parallel longitudinal screw driver head grooves 28 extending into and arrayed equally-spaced circumferentially around the screw driver head 24. As shown in FIG. 6, the frustum may be 0.0670 inch in diameter. As best shown in FIG. 6, there may be six splines 26, each of which may have a width of 0.0100 inch at an outer surface 30 of the spherical frustum. However, in other embodiments, the dimensions of the frustum and splines 26 may be of any suitable value, and there may be any suitable number of splines 26 formed in the frustum.

As best shown in FIG. 6, each screw driver head groove 28 may have an arcuate transverse profile along a radial cross-section cut by a radial plane passing through the screw driver head groove perpendicular to a rotational axis 32 of the screw driver 22. As is also best shown in FIG. 6, the transverse profile of each screw driver head groove 28 may have a radius of 0.010 inch. However, in other embodiments, the radius of the transverse profile of each screw driver head groove 28 may be of any suitable value.

As best shown in FIG. 9, a radially inner apex 34 of each screw driver head groove 28 may have a convex curved axial profile along its length along an axial cross section cut by an axial plane along the groove 28, i.e., by a plane coincident with the rotational axis 32 of the screw driver 22. In the embodiment shown in the drawings, and as shown in FIG. 9, the convex curved axial profile of each screw driver head groove 28 may have a radius of 0.081 inch. However, in other embodiments, the convex curved axial profile of each screw driver head groove apex 34 may be of any suitable value. Each driver head groove 28 may flow continuously into a corresponding driver shaft groove 36 that may, as best shown in FIG. 9, have a radially inner apex having a concave curved axial profile along its length along an axial cross section cut by an axial plane along the groove 36.

As best shown in FIGS. 11-13, the screw head recess 18 may extend axially inward from the end surface 20 of the screw head 16 of the screw 12, and may taper radially inwardly. The screw head recess 18 may include screw head recess grooves 38 that may be arranged circumferentially and equally spaced around and formed radially outwardly from an inner circumferential surface of the screw head recess 18 into the screw head 16 as best shown in FIG. 11. As best shown in FIGS. 12 and 13, the screw head recess grooves 38 may extend axially inward from the end surface 20 of the screw head 16, and may be angled radially inward toward a rotational axis 40 of the screw 12, leaving radially-inward angled surfaces extending between them. As shown in FIG. 11, the screw 12 may include six such screw head recess grooves 38. However, in other embodiments, the screw 12 may include any suitable number of screw head recess grooves 38.

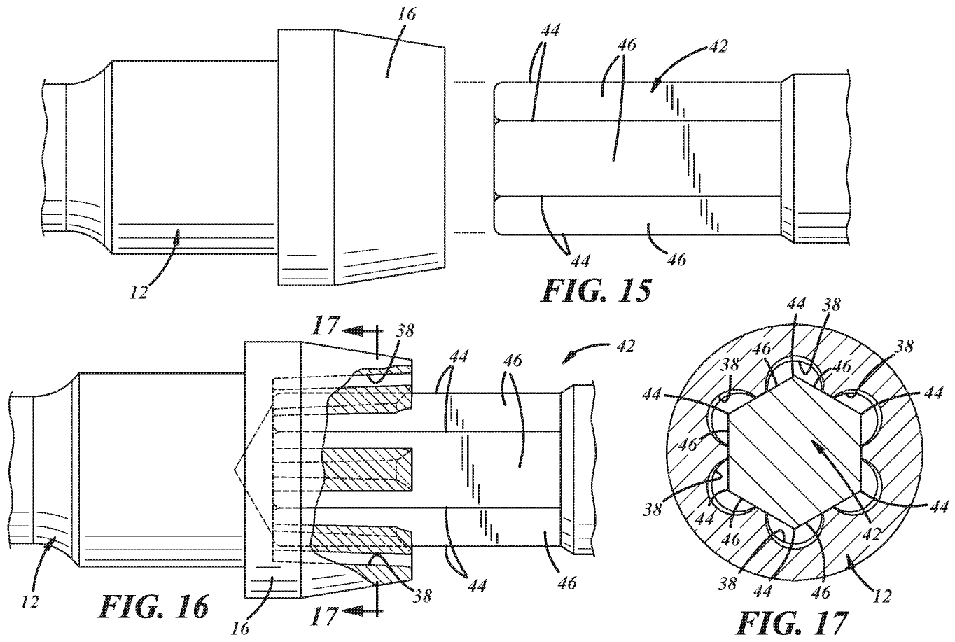

As shown in FIGS. 15 and 16, the screw head recess 18 may be further configured to receive engagement, torque transmission, and rotational motion impartation from a conventional hex head cap screw driver 42 in coaxial alignment with the screw 12. As best shown in FIG. 17, corners 44 formed at intersections 44 of facets 46 of a conventional hex head cap screw driver 42 are received in the screw head recess grooves 38 of the screw 12.

In practice, this system 10 can be used to drive the screw 12 into threaded engagement, by first positioning either the screw 12 for threaded insertion into, for example, bone tissue, and engaging the screw driver head 24 with the screw head 16 such that at least some of the splines 26 of the screw driver head 24 are at least partially received in the screw head recess grooves 38. The screw 12 may then be rotated and driven into threaded engagement with the bone tissue by rotating the screw driver 22 and applying sufficient axial pressure to the screw driver 22 to prevent the screw driver head splines 26 from skipping out of engagement with the screw head recess grooves 38.

This system 10 can also be used to remove the screw 12 from threaded engagement from, for example, bone tissue, by engaging the screw driver head 24 with the screw head 16 such that at least some of the splines 26 of the screw driver head 24 are at least partially received in the screw head recess grooves 38. The screw 12 may then be rotated and backed-out from threaded engagement with the bone tissue by rotating the screw driver 22 and applying sufficient axial pressure to the screw driver 22 to prevent the screw driver head splines 26 from skipping out of engagement with the screw head recess grooves 38.

In the embodiment shown in the drawings, the configuration of the screw driver head 24 and screw head recess 18 allow for transmission of approximately 35 Ncm of torque from the screw driver 22 to the screw 12, with the screw driver rotational axis 32 and screw rotational axis 40 being at any included angle in the range of 180 degrees through approximately 165 degrees, and without causing any visual deformation to either the screw head recess 18 or the screw driver head 24. This is sufficient torque transmission to drive the screw 12 into bone tissue, and to remove the screw 12 from bone tissue.

Alternatively, the screw 12 may be driven into threaded engagement with the bone tissue, or removed from such engagement, by first inserting the head of a conventional hex head cap screw driver 42 into the screw head recess 18 with the cap screw driver 42 in approximate axial alignment with the screw 12 as shown in FIGS. 16 and 17. Torque and rotational motion may then be applied to the screw 12 via the cap screw driver 42, while maintaining approximate axial alignment, to drive the screw 12 either into or out of threaded engagement.

This description, rather than describing limitations of an invention, only illustrates an embodiment of the invention recited in the claims. The language of this description is therefore exclusively descriptive and is non-limiting.

Obviously, it's possible to modify this invention from what the description teaches. Within the scope of the claims, one may practice the invention other than as described above.

What is claimed is:

1. A screw engagement system for transmission of torque and rotational motion from a screw driver to a screw, the system comprising:
a screw comprising a screw shaft axially extending from a screw head, and a screw head recess formed axially into the screw head from an end surface of the screw head, the screw head recess including a plurality of screw head recess grooves arranged circumferentially around and formed radially outwardly into the screw head from an inner circumferential surface of the screw head recess; and
a driver comprising a driver head having the general shape of a spherical frustum and including a plurality of splines that are defined by driver head grooves formed into and arrayed circumferentially around the driver head, and that are configured to engage the screw head recess grooves and transmit torque and impart rotational motion to the screw therethrough.

2. A screw engagement system as defined in claim 1 in which each driver head groove has an arcuate transverse profile along a radial cross-section cut by a radial plane passing through the driver head groove perpendicular to a rotational axis of the driver.

3. A screw engagement system as defined in claim 1 in which a radially inner apex of each driver head groove has a convex curved axial profile along its length along an axial cross section cut by an axial plane.

4. A screw engagement system as defined in claim 1 in which the screw head recess grooves are angled radially inward toward a rotational axis of the screw.

5. A screw engagement system as defined in claim 4 in which the screw head recess is tapered radially inwardly.

6. A screw engagement system as defined in claim 4 in which the screw includes six screw head recess grooves.

7. A screw engagement system as defined in claim 1 in which the driver head and screw head recess are configured to transmit up to 35 Ncm torque to drive the screw 12 into bone tissue with the screw driver rotational axis 32 and screw rotational axis 40 being at an included angle of up to 165 degrees.

8. A screw engagement system as defined in claim 1 in which the driver head and screw head recess are configured to transmit up to 35 Ncm torque to remove the screw 12 from bone tissue with the screw driver rotational axis 32 and screw rotational axis 40 being at any included angle of up to 165 degrees.

9. A screw comprising:
a screw shaft axially extending from a screw head; and
a screw head recess formed axially into the screw head from an end surface of the screw head, the screw head recess including six screw head recess grooves arranged circumferentially around and formed radially outwardly into the screw head from an inner circumferential surface of the screw head recess, the screw head recess being configured:
to receive a driver comprising a driver head having the general shape of a spherical frustum and including a plurality of driver head splines that are defined by driver head grooves formed into and arrayed circumferentially around the driver head, the screw head recess grooves being configured and positioned to receive and engage the driver head splines and to receive torque transmission and rotational motion therethrough; and
to receive a driver comprising a driver head having the general shape of a hexagonal prism and including six driver head corners that are defined by intersections of six facets arrayed circumferentially around the driver head, the screw head recess grooves being configured and positioned to receive and engage the driver head corners and to receive torque transmission and rotational motion therethrough.

10. A screw engagement system as defined in claim 9 in which the screw head recess grooves are angled radially inward toward a rotational axis of the screw.

11. A screw engagement system as defined in claim 10 in which the screw head recess is tapered radially inwardly.
